(19) United States
(12) Patent Application Publication
(10) Pub. No.: US 2013/0048420 A1
(43) Pub. Date: Feb. 28, 2013

(54) METHODS, SYSTEMS AND APPARATUS DIRECTED TO SAFETY HARNESSES, AND TOOL BAGS AND HOLDERS, FOR CONSTRUCTION WORKERS AND THE LIKE

(71) Applicant: STEVEN C. NICHOLS, JR., WOODINVILLE, WA (US)

(72) Inventor: STEVEN C. NICHOLS, JR., WOODINVILLE, WA (US)

(21) Appl. No.: 13/598,525

(22) Filed: Aug. 29, 2012

Related U.S. Application Data
(63) Continuation of application No. 12/823,457, filed on Jun. 25, 2010.
(60) Provisional application No. 61/220,533, filed on Jun. 25, 2009.

(51) Int. Cl. A62B 35/00

(52) U.S. Cl. 182/3

(57) ABSTRACT

A full body safety harness system wherein at least 50% of its outwardly visible surface comprises highly visible outer material comprising at least one of a high visibility background material in combination with retroreflective material or a dual purpose retroreflective material.

### PRIORITY CLAIM

The present application claims the benefit of copending U.S. Provisional Patent Application No. 61/220,533, filed Jun. 25, 2009, which application is incorporated herein by reference in its entirety.

### BACKGROUND

Prior safety harnesses for industrial workers have not always provided the safety, consistency, flexibility of use, or comfort that may be desired. The various aspects of the improved safety harnesses discussed herein provide improvements in one or more of these or other areas.

### SUMMARY

The present systems and methods, etc., are directed to full body safety harnesses that comply with governmental safety standards such as ANSI and OSHA safety standards for fall arrest. For example, such systems, etc., are configured to prevent serious injury to a worker after 6 feet (2 meters) of free fall. In various aspects and embodiments, which can be combined, permuted, etc., as desired, the industrial safety harnesses comprise one or more of: 1) A substantially rigid, resilient and water-resistant core throughout substantially the entire body harness frame (i.e., at least the shoulder straps, leg straps and torso assembly). The fabric surrounding the core can also be resilient and water resistant. Further, the layers of such core and fabric can he laminated to together to provide, e.g., additional strength, wear resistance and/or water resistance. 2) Serpentine shoulder straps having an S-configuration (more “curves” can be provided if desired) from at least the central crossing point of the back-shoulder straps. 3) An integrated, fixed chest strap disposed between shoulder straps of a safety harness, which shoulder straps extend from the front to back of the belt-portion of the harness, which chest strap is not vertically adjustable relative to the rest of the harness (and therefore a user wearing the harness). 4) An integrated tool bag attachment configuration that comprises an elongated horizontal element wherein the full body harness is configured to comfortably, safely and reliably hold the heavy tool bag that a construction worker such as a carpenter or lineman may wear. Advantageously, the tool bag is secured, directly or indirectly, to the full body harness itself and not merely to an unconnected, separate, less-sturdy tool belt or tool harness made of materials inadequate for a safety harness. This eliminates the expense of the additional equipment while improving safety and comfort by reducing the size and number of different pieces of equipment the worker needs to wear. Such tool bag attachment configuration comprises a plurality of spacer elements located to allow movement of the tool bag by the user within pre-defined areas along an elongated horizontal element attached to at least the lower back region of the harness's back straps. The elongated horizontal element may be permanently integrated into the structure of the harness or releasably attachable, such as an integrated belt that in turn attaches to back or waist straps of the harness. 5) A safety line attachment element guard configured to hold a safety line attachment element such as a D-ring out of the way when not in use. For example, the safety line attachment element guard can be a belt-loop type device located adjacent the safety line attachment element on a back strap or waist belt of the full body harness, then the safety line attachment element can be tucked under a belt loop when not in use. This can be particularly advantageous for safety harnesses comprising additional side D-ring(s) so that such side safety line attachment elements do not inadvertently catch onto external objects, particularly if such side D-rings are permanently attached to the full body harness. 6) A unitized harness frame wherein substantially all of the harness has the substantially rigid, resilient and water-resistant core discussed above. Such core can also provide a harness that is fully padded (frame, waist belt and leg pads can all contain the foam core). 7) An elongated, elasticized webbing keeper that is longer than it is wide and fits like a sleeve over both the feed portion and the loose end of any loose webbing that can fold back on itself, such as end of a thin nylon strap that passes through an adjustment buckle (or other webbing length adjustor). In one embodiment, the webbing (i.e., a strong, flat, high-tensile strength strip of material such as nylon fabric) is fed through the elongated, elasticized webbing keeper, then through the adjustment buckle, then back through the elongated, elasticized webbing keeper. This securely holds the loose end of the strap in place, reducing the possibility of it interfering with the work of the user and reducing safety hazards as well. 8) Visible outer material (i.e., material that is visible to non-wearers of the harness when the harness is being worn, i.e., the outward-facing chest, back, side and/or shoulder areas) comprising a high visibility background material in combination with retroreflective material (the retroreflective material can be, for example, a combined performance material). A combination of high visibility background-retroreflective materials can be found on light, loose safety vests worn for example by street paving workers but has never before been found on a safety harness configured for safety fall arrest as discussed herein, particularly in quantities and locations adequate to provide safety visibility for a wearer from all major positions for the wearer: from the front, side, back and over the shoulder (for when the wearer is lying down or bent over).

In one aspect, the present systems, devices and methods relate to full body safety harness systems comprising a full body safety harness frame, the frame configured to safely protect a worker in a fail arrest situation and comprising shoulder straps, back straps, and a torso assembly, wherein the shoulder straps, back straps and torso assembly all can comprise a substantially rigid, resilient and water-resistant core configured such that the shoulder straps, back straps and a torso are all resistant to folding and crimping and do not absorb substantial amounts of water. The body harness frame further can comprise leg straps comprising the substantially rigid, resilient and water-resistant core, the substantially rigid, resilient and water-resistant core comprising a resilient closed-cell foam enclosed within a protective fabric.

The substantially rigid, resilient and water-resistant core and the protective fabric can be laminated to each other. The core can be essentially contiguous throughout all portions of the full body harness and the core can be essentially unitary throughout all portions of the full body harness can comprise the core. The fabric can be made of polyester.

In another aspect, the systems, etc., are directed to a full body safety harness system comprising a full body safety harness frame, the frame configured to safely protect a worker in a fall arrest situation and comprising at least one serpentine shoulder strap comprising an S-configuration, wherein a first end of the serpentine shoulder strap contacts a central crossing point corresponding to a middle of a user's back when the harness is in use, wherein as the serpentine shoulder strap rises from the crossing point the strap angles outwardly away from a centerline of the harness and away from where a user's neck would be when the harness is in use to provide an outward curve, then curve inwardly toward the centerline of the harness to provide an inward curve. In some embodiments, after the inward curve, the serpentine shoulder strap curves outwardly again, away from the centerline of the harness, to provide a second outward curve. The harness can comprise two serpentine shoulder straps and the two serpentine shoulder straps can comprise corresponding, opposing inward and outward curves. Additional curves can be provided as desired.

The central crossing point further can comprise a safe line attachment assembly, the safety-line attachment assembly comprising a D-ring assembly comprising a D-ring plate and a D-ring, and the serpentine effect can be achieved using all curves or all angles or combinations of the two or otherwise as desired. The upper serpentine shoulder strap further can comprise a lower-extending leg strap that is or is not serpentine.

In a further aspect, the systems, etc., are directed to a full body safety harness system comprising a full body safety harness frame, the frame configured to safely protect a worker in a fall arrest situation and comprising two opposed shoulder straps that extend from a central crossing point corresponding to a middle of a user's back when the harness is in use, over a user's shoulders and down a user's chest, which portion corresponding to the user's chest defines a chest portion of the shoulder straps. The chest portion can comprise an integrated chest strap extending from and joining one shoulder strap to the other. The integrated chest strap can be immovably attached to the chest portions of the shoulder straps. The integrated chest strap can be unitary with the chest portions of the shoulder straps, and can be horizontal adjustable,

In still another aspect, the systems, etc., are directed to a full body safety harness system comprising a full body safety harness frame, the frame configured to safely protect a worker in a fall arrest situation and can comprise shoulder straps, back straps, leg straps and a torso assembly, wherein the torso assembly can comprise an elongated horizontal element attached to at least a lower back region of the back straps at about waist or hip level of a user when the harness is in use, wherein the elongated horizontal element can comprise first and/or second tool bag holding areas defined by end members and located at either hip of a user when the harness is in use. The tool bag holding areas each can comprise at least one retaining element configured to selectively and securely retain a tool bag at any one of a plurality of desired locations within the respective tool bag holding area.

The elongated horizontal element can comprise a series of retention elements such as projections defining ends of the tool bag holding areas, the retention elements can be for example belt loops, and the elongated horizontal element can comprise an attachable heavy duty utility belt configured to hold equipment such as hammers and levels, and belt loops that carry the heavy duty utility belt. The heavy duty utility belt can contain the tool bag holding area end members.

The full body harness system further can comprise at least one tool hag configured to cooperatively interact with the tool bag holding area of the elongated horizontal element such that a top of the tool bag that interacts with the tool bag holding area can be enough shorter than a length of the tool bag holding area to provide multiple different locations along the tool bag holding area suitable for holding the tool bag (in other words, the top of the tool bag can be significantly shorter than the length of the tool hag holding area such that the tool bag can be moved to various desired locations within the tool bag holding area). The full body harness system can comprise two bags, wherein at least one tool bag is located at each of first and second tool bag holding areas located at either hip of a user when in use. The elongated horizontal element can be a waist belt encircling a wearer when in use, the waist belt can be about 48 inches long and can comprise self-adhering elements such that about 20 inches of an interior side of a second end of the waist belt extends beyond and adheres to and exterior side of a first end of the waist belt, or the substantially elongated horizontal element can be an element extending from a lower portion of a chest strap-around the back-to a corresponding lower portion of the other chest strap.

The substantially elongated horizontal element can be permanently or releasably attached to at least a lower back region of the back straps of the full body harness. The elongated horizontal element can comprise a series of belt loops defining the tool bag holding areas, wherein the belt loops can comprise a middle belt loop located at a center (midline) location of a user when in use and 2 pairs of belt loops located at either side and defining right and left tool bag holding areas corresponding to the right and left sides of a user when in use. Each pair of belt loops also defines a beginning and ending of a right and left tool bag holding area, respectively.

The elongated horizontal element further can comprise a first belt loop located at a first end of the elongated horizontal element and configured to hold an end of an attachable heavy duty utility belt, a second and third loop defining a first of the 2 pairs and spaced about 8″ apart, a fourth belt loop located at the center back of a user when the belt is on the user, and a fifth and sixth loop defining a second of the 2 pairs and spaced about 8″ apart, wherein the first and second pairs are each located an equal space of about 3.5 inches on either side of the fourth belt loop.

The elongated horizontal element further can comprise a first belt loop located at a first end of the elongated horizontal element and configured to hold an end of an attachable heavy duty utility belt, a second and third loop defining a first of the 2 pairs and spaced about 13″ apart, the third and a fourth loop defining a second of the 2 pairs and spaced about 13″ apart, wherein the third belt loop can be located at the center back of a user when the belt is in user. The tool bag also can contain a retaining element, for example the tool bag and tool bag retaining area each can comprise corresponding components of a hook and loop material such as VELCRO® or the corresponding components of at least one snap. The elongated horizontal element further can comprise a hammer holder, and the elongated horizontal element and the hammer holder can comprise cooperative retaining elements such the hammer holder can be movable on the elongated horizontal element from one side of the elongated horizontal element to another.

In still yet another further aspect, the systems, etc., are directed to safety harnesses comprising highly visible outer material comprising reflective material such as a high visibility background material in combination with retroreflective material and/or dual purpose retroreflective material. Such reflective material is present in quantities and locations adequate to provide safety visibility for a wearer at all major positions for the wearer: from the front, side, back and over the shoulder (for when the wearer is lying down or bent over). In some embodiments, the high visibility background-retroreflective material covers at least 50%, 70%, 75%, or even 80% or 90% or more, of the outwardly visible surface of the harness (outwardly visible means visible to a non-wearer when the harness is in use on a wearer, and thus does not include for example the inward-facing surfaces of the straps that face toward the body of the wearer). in some embodiments, the visible outer material and fall arrest harness complies with ANSI 107-2010 requirements for class 1 apparel non-fall-arrest safety vests. In certain embodiments, the visible outer material comprises (in outwardly visible locations as noted above): A) background material 217 in² (0.14 m²) with retroreflective or combined performance material 155 in² (0.10 m²); B) retroreflective that is combined-performance material used without background material 310 in² (0.20 m²). The minimum width of the retroreflective material can be 1in. (25 mm) or 2 in. (50 mm) if combined-performance material is used without background material. The minimum number of yards of retroreflective material per retroreflective material width can be: a) 4.3 yds. of 1 in. (25 mm); b) 3.1 yds. of 1.372 in. (35 mm) width; or c) 2.15 yds. of 2 in. (50 mm) width. An exemplary ANSI standard is discussed and can be found for example in a brochure found at http://multimedia.3m.com/mws/mediawebserver?mwsld=SSSSSu7zK1fslxtUMs_en8mZev7gel7zHvTSevTSeSSSSSS——.

In still yet another further aspect, the systems, etc., are directed to a full body safety harness system comprising a full body safety harness frame, the frame configured to safely protect a worker in a fall arrest situation and comprising a body harness frame comprising shoulder straps, back straps, leg straps and a torso assembly, wherein the body harness frame further can comprise a safety line attachment element and an adjacent safety line attachment element guard, wherein the safety line attachment element and the adjacent safety line attachment element guard are configured to cooperatively interact such that the adjacent safety line attachment element guard releasably, securely holds the safety line attachment element in a safe and out-of-the-way position when the safety line attachment element not connected to a safety line.

The safety line attachment element can be, for example, a D-ring located on a right or left side of the harness, the safety line attachment element guard can be, for example, a belt loop sized and configured to receive the safety line attachment element. In some embodiments, the safety line attachment element and safety line attachment element guard are co-located such that the D-ring can be folded towards the belt and placed under the belt loop.

The torso assembly can comprise an elongated horizontal element attached to at least a lower back region of the back straps at about waist or hip level of a user when the harness is in use, and wherein the safety line attachment element guard can be directly connected to the elongated horizontal element.

The elongated horizontal element can comprise an attachable or permanent heavy duty utility belt and if the utility belt is detachable, the elongated horizontal element can comprise belt loops that carry the heavy duty utility belt and the safety line attachment element guard can be directly connected to the heavy duty utility belt.

In another aspect, the systems, etc., are directed to a webbing keeper system comprising a webbing and an elongated, elasticized webbing keeper sized and configured to ensleeve at least a free end of the webbing, wherein the elongated, elasticized webbing keeper can comprise a width dimension sized to friction fit a width of the webbing. The elongated, elasticized webbing keeper is longer than it is wide, which provides significantly better retention of the webbing than conventional belt-loop type webbing holders. The system further can comprise an adjustment loop comprising the webbing and a webbing length adjustor wherein the webbing passes through the webbing length adjustor then folds back onto itself, and wherein the elongated, elasticized webbing keeper further holds at least one segment of webbing located before the webbing length adjustor as well as the end of the webbing downstream from the adjustor. For example, the webbing length adjustor can be an adjustment buckle.

In still yet another further aspect, the systems, etc., are directed to a tool bag configured to hold industrial tools such as for a construction worker. The tool bag comprises a pouch sized and configured for securely carrying construction tools, an upper edge defining an opening to the pouch and a lower edge defining a lower edge of the pouch, wherein the linear length of the opening is shorter than the linear length of the lower edge of the pouch (i.e., the linear length from the right edge to the left edge of the pouch, not including the circumference nor width of the lower edge) to form a pouch having an opening that is smaller than the pouch below it. The upper edge can be about inches in length and the lower edge can be about 7.5 inches in length, the tool bag further can comprise at least one drain hole in the bottom of the bag, which can be defined, e.g., by a grommet. The tool bag further can comprise an accessory bag attachment system configured to attach to and hold at least a top surface and a bottom surface of at least one accessory bag. The top surface and bottom surface are typically the top of the back of the accessory bag and the bottom of the back of the accessory bag.

In still yet another further aspect, the systems, etc., are directed to a speed square pocket comprising dual speed square retention areas. The speed square pocket can comprise a w-shape comprising a top opening and opposed triangular recesses, the first triangular recess extending downward from the opening and sized and configured to hold a speed square in a right-hand orientation, and the second triangular recess extending downward from the opening and sized and configured to hold the speed square in a left-hand orientation. Thus, the opposed triangular recesses define sharply angled opposed recesses ending in downward facing triangular points (the “points” may be radiused or otherwise eased as desired).

In still another further aspect, some of the systems, etc., herein relate to industrial body harness systems similar to the preceding full body harness except the harness is not configured for fall arrest situations.

The full body safety harness systems herein can comprise the elements of at least two, three, four, five or more, up to all, of the aspects discussed herein.

These and other aspects, features and embodiments are set forth within this application, including the following Detailed Description and attached drawings. Unless expressly stated otherwise, all embodiments, aspects, features, etc., can be mixed and matched, combined and permuted in any desired manner.

### BRIEF DESCRIPTION OF THE DRAWINGS

FIG. 1 depicts a front plan view of an exemplary safety harness as discussed herein.

FIG. 2 depicts a side plan view of an exemplary safety harness as discussed herein.

FIG. 3 depicts a back plan view of an exemplary safety harness as discussed herein.

FIG. 4 depicts a back plan view of an exemplary safety harness as discussed herein wherein the harness is splayed out.

FIG. 5 depicts a schematic plan view of serpentine shoulder straps for an exemplary safety harness as discussed herein.

FIG. 6 depicts a front plan view of a chest strap for an exemplary safety harness as discussed herein wherein the clasp is open.

FIG. 7 depicts a front plan view of a chest strap for an exemplary safety harness as discussed herein wherein the clasp is closed.

FIG. 8A depicts a front plan view of a waist belt for an exemplary safety harness as discussed herein, wherein the belt loops of the waist belt are open.

FIG. 8B depicts a front plan view of a waist belt for an exemplary safety harness as discussed herein along with two tool pouches to be attached to the waist belt.

FIG. 9 depicts a plan view of a safety line attachment element guard for an exemplary safety harness as discussed herein wherein the safety line attachment element is a D-ring shown inside the safety line attachment element guard.

FIG. 10 depicts a plan view of a safety line attachment element guard for an exemplary safety harness as discussed herein wherein the safety line attachment element is a D-ring shown outside the safety line attachment element guard.

FIG. 11 depicts a plan view of a webbing keeper for an exemplary safety harness as discussed herein wherein the webbing is shown outside the webbing keeper.

FIG. 12 depicts a plan view of a webbing keeper for an exemplary safety harness as discussed herein wherein the webbing is shown inside the webbing keeper.

FIG. 13 depicts a side view of a tool pouch and tool accessory pouch for an exemplary safety harness as discussed herein wherein the lower portion of the tool accessory pouch is not attached to the primary tool pouch.

FIG. 14 depicts a side view of a tool pouch and tool accessory pouch for an exemplary safety harness as discussed herein wherein the lower portion of the tool accessory pouch is not attached to the primary tool pouch.

FIG. 15 depicts a plan view of a speed square pocket and speed square as discussed herein,

### DETAILED DESCRIPTION

The present systems and methods provide enhanced safety, comfort and/or usability for industrial workers such as construction workers, roofers, carpenters and the like. The devices, systems, methods, etc., herein, comprise full body safety harnesses configured to safely protect a worker in a fall arrest situation, which harnesses incorporate one, two, three or more of the plurality of different features discussed herein. The full body harness can he made of any suitable material(s) capable of providing the necessary strength, comfort and safety required for a fall arrest full body safety harness. In some embodiments, the fabric portions of the harnesses discussed herein are made of 100% polyester construction.

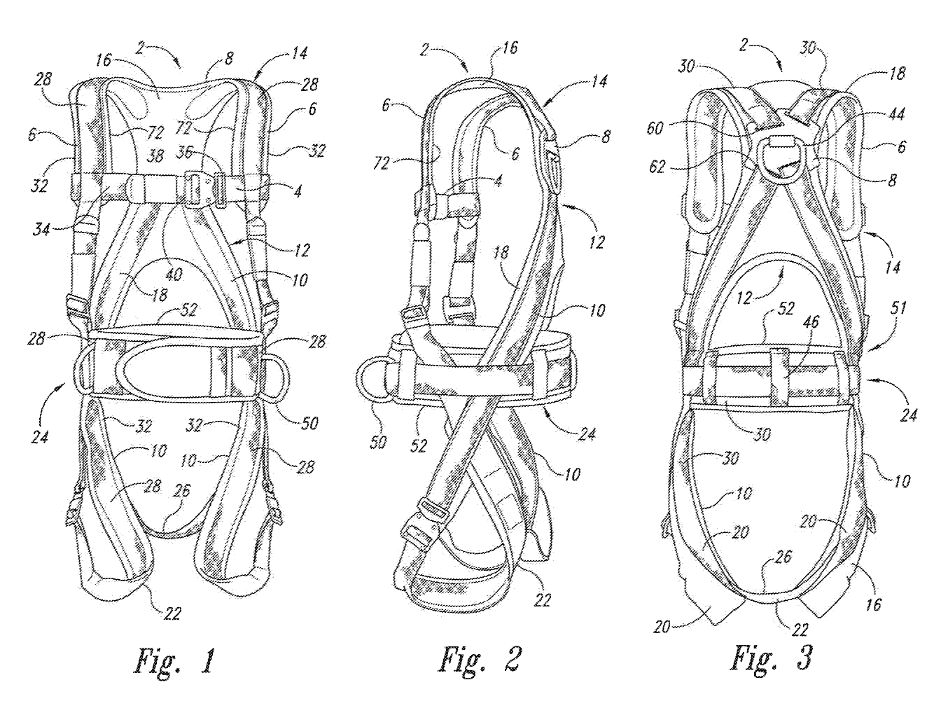

Turning to the figures, FIGS. 1-4 depict an exemplary full body harness 2 as discussed herein, wherein substantially the entire full body harness frame 14 (i.e., at least the shoulder straps 6, leg straps 10 and torso assembly 12 (including back 8)) has a substantially rigid, resilient and water-resistant core 18 such that the safety harness frame 14 is resistant to folding, crimping, etc., and substantially does not pick up nor retain liquids, i.e., absorb substantial amount of liquids, for example due to rainfall, spray from a hose or spilled beverages. In certain embodiments, the resilient core 18 is made up of a resilient closed-cell foam, for example ⅛″ to ⅜″ thick, that is slightly flexible and pliable so that it can conform to worker movement and body shape, yet is resilient to withstand crimping or bunching on the body of the worker, which may be uncomfortable or deleterious to the functioning of the full body harness 2.

The substantially resilient core 18 is essentially contiguous throughout the safety harness frame 14. If desired, the core 18 can be unitary throughout the entire safety harness; “unitary” means the core 18 is made of a single piece of the closed-cell foam (or other suitable material). Typically, as in FIGS. 1-4, the core 18 is covered by a cover fabric 16 such as nylon or other suitable material. In some embodiments, the layers of foam and fabric are laminated together, which means the layers are immovably attached to each other for example via heat melding, gluing or sewing. Such lamination can provide one or more of enhanced resistance to moisture, enhanced wear properties, enhanced comfort, etc.

Such an essentially contiguous core 18 can provide one or more of the following advantages: the harness frame can retain its shape, the harness frame can feature greater comfort, and the harness frame can provide a more resilient structure for attachment of a chest strap 4 such as the vertically-fixed chest strap discussed herein, to thereby provide a more complete structural device and system overall. In FIGS. 1-3, the core 18 is coextensive with the frame 14, so thin, flexible, high tensile strength webbing or other suitable material extends from the ends or edges of the frame to connect the different parts of the frame. For example, in FIGS. 1-3, frame 14 can end at waist belt 24 (FIG. 1) or at lower extremity 20 of frame 14 (FIG. 3), then leg webbings 22 connect the back leg straps 10 of frame 14 to front of shoulder straps 6. As desired, the harness 2 can have a leg strap bridge 26.

Harness 2, as shown for example in FIGS. 1-3, can comprise reflective material such as retroreflective material 28. In FIG. 1, the retroreflective material is located atop a high visibility background material 32. In FIG. 3, the reflective material is a combined performance material 30.

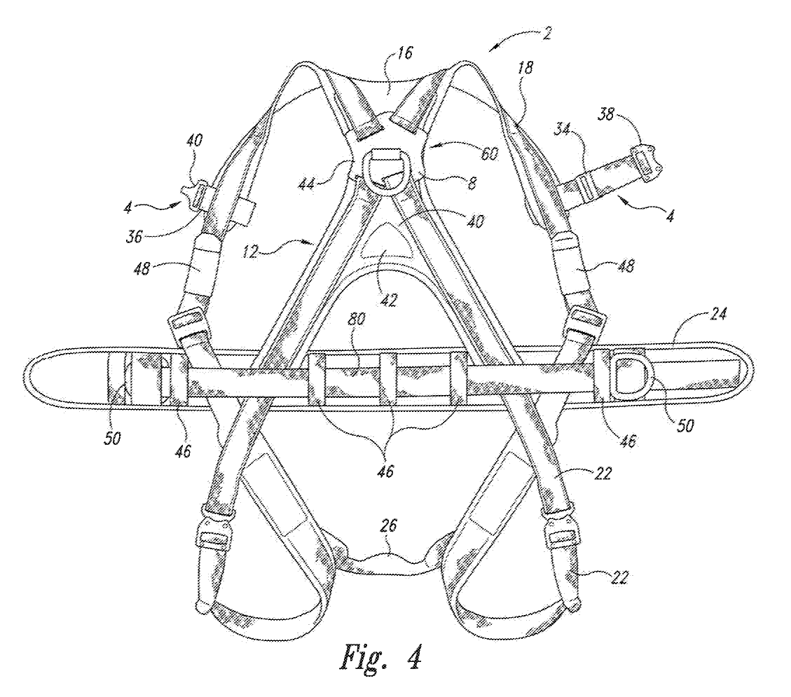

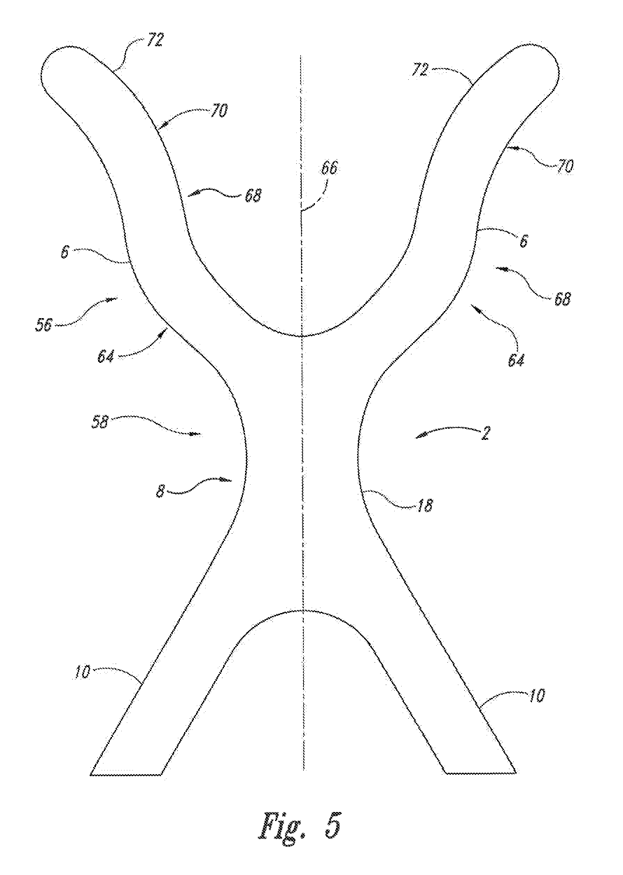

As perhaps best shown in FIG. 5, in a further aspect, the full body harness 2 comprises serpentine shoulder straps 6 having an S-configuration 56 from at least the central crossing point 58 of the back-shoulder straps. The central crossing point 58 is located at about the middle of the back of a user. As shown in FIGS. 3 and 4, central crossing point 58 is a suitable location for the safety-line attachment assembly 60, which safety-line attachment assembly 60 is typically a D-ring assembly comprising a D-ring plate 62 and a back D-ring 44 but can be any suitable attachment element. Central crossing point 58 can also be a suitable location for a logo 42 or other written or symbolic material. Returning to the S-configuration 56, rising from the central crossing point 58 (and safety-line attachment assembly 60), when the harness is laid flat as in FIG. 5, the shoulder straps 6 first angle outwardly 64 away from the centerline 66 of the harness 2 (and away from where a user's neck would be), then have an inward curve 68 back toward the centerline 66 of the harness 2. If desired, the serpentine shoulder straps 6 can then curve outwardly 70 again, away from the centerline 66 of the assembly/a user's body. The serpentine effect can, if desired, be achieved using all curves, all angles, or a combination of the two. Other or different curves or angles can also be used provided such enhance the comfort or safety of the user without substantially detracting from the safety of the full body harness 2. In one embodiment, the shoulder straps 6 (e.g., the upper straps extending from the safety-line attachment assembly 60 in FIG. 5) are serpentine while the lower-extending leg straps the lower straps extending from the safety-line attachment assembly 60 in FIG. 5) are not serpentine.

In one embodiment, the use of a serpentine design at the shoulders permits the frame legs, to which the chest strap(s) 4 is attached, to fit comfortably around the shoulders without restricting neck movement. This same serpentine design can allow the front portion 72 of the shoulder straps 6 to rest vertically in the front where the chest strap 4 is attached.

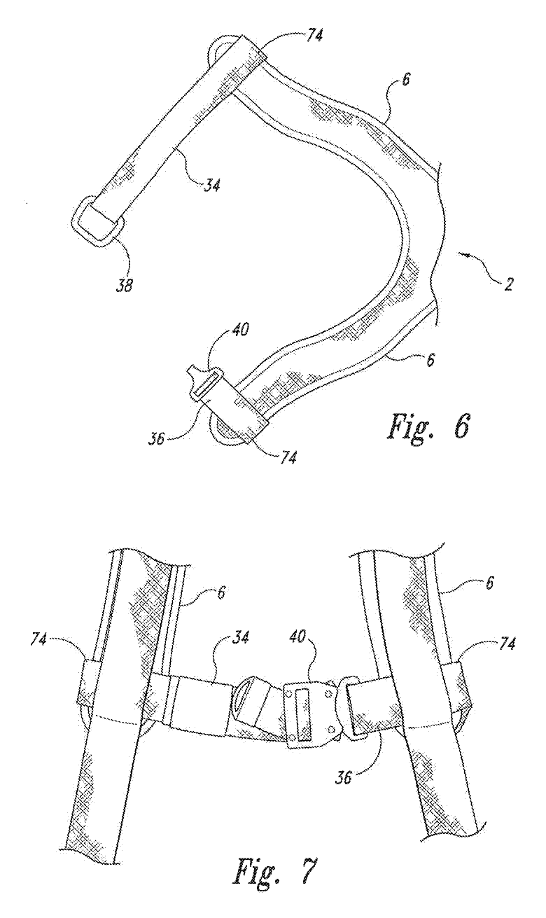

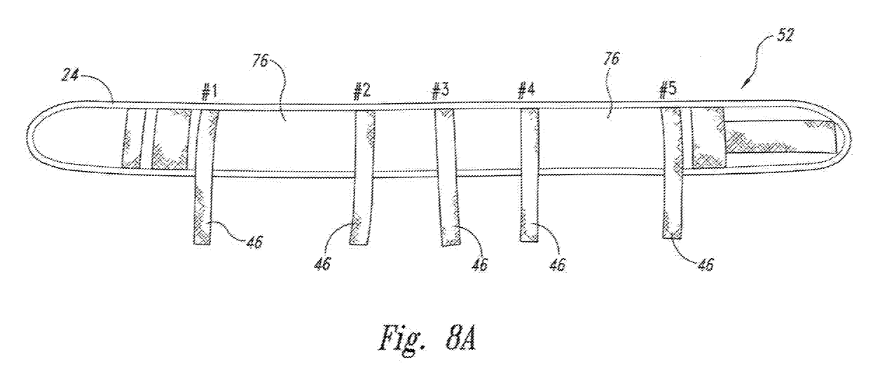

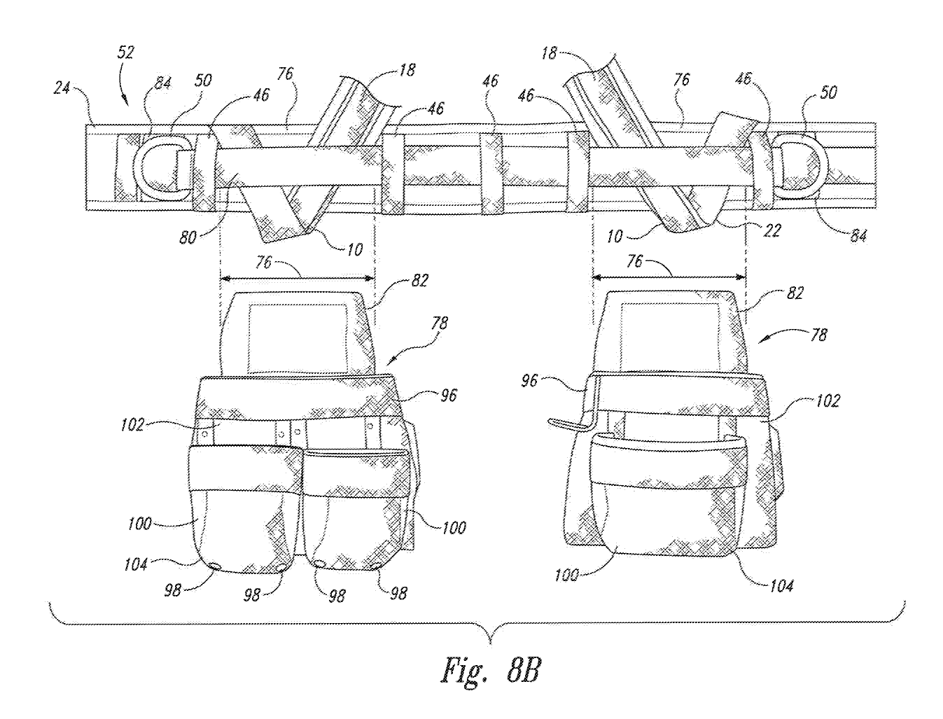

Turning to FIGS. 6 and 7, in another aspect, the full body harnesses 2 herein comprise a chest strap 4 that is integrated with the full body harness's front shoulder straps 6 such that the chest strap 4 does not move vertically relative to such front shoulder straps 6. Briefly, the chest strap 4 provides width adjustment via a suitable closure such as a horizontally adjustable end 34 comprising such as female buckle 33 and a corresponding horizontally adjustable end 36 comprising a male buckle 40, yet chest strap 4 is permanently attached to or unitarily incorporated into the shoulder straps 6 at a permanent attachment site 74 located at a user's chest such that the chest strap 4 cannot be adjusted vertically, although horizontal adjustment of the chest strap 4 may be provided if desired to account for bodies of different widths. This can reduce the cost of manufacture of the full body harness 2, eliminate unwanted movement of the chest strap 4, and can provide for a more secure attachment of the chest strap 4 to the shoulder straps 6. Surprisingly, this configuration still allows for workers of different height and weight to adjust the harness to accommodate for their different sizes, because it has been found that vertical adjustment of the chest strap 4 is not necessary for such accommodations.

Turning to FIGS. 8A and 8B, In a further aspect, the full body harness 2 comprises an elongated horizontal element 52 comprising a waist belt 24 permanently or releasably attached to at least the lower back region of the harness's back straps (i.e., at about waist or hip level) and configured to selectively moveably carry heavy tool bags 78 at a specifically desired location along the elongated horizontal element 52. Such elongated horizontal element 52 and tool bags 78 are configured to carry heavy tools such as power tools, screwdrivers, hammers, levels, tape measures, etc. The elongated horizontal element 52 comprises a series of positioning elements such as belt loops 46 defining at least one tool bag holding area 76 located about the location of one of a user's hips when in use, the tool bag holding areas 76 configured to selectively position and carry at least one heavy tool bag 78 at a specifically desired location along at least one of the tool bag holding area 76. In FIG. 8A, the belt loops 46 are laid open so that they can receive a heavy duty utility belt 80. Such heavy duty utility belt 80 can provide a location to attach the heavy tool bag 78, for example by wrapping a top 82 of the bag over the heavy duty utility belt 80 then connecting it back to the tool bag itself Other attachment mechanisms or assemblies can also be used. In FIG. 8B, the belt loops 46 are closed with a heavy duty utility belt 80 held therein.

The elongated horizontal element 52 can be, for example, a waist belt encircling a wearer or an element extending from back-strap to back-strap, or an element extending from a lower portion of a chest strap-around the back-to a corresponding lower portion of the other chest strap. The waist belt is integrated into the full body harness 2 and is broad enough and sturdy enough to safely, and preferably comfortably, hold at least one tool bag 78 to the full body harness 2. In certain embodiments, the elongated horizontal element 52 comprises a plurality, typically four, five or six, of integrated belt loops 46 strong enough to hold at least one tool bag 78 in place along the elongated horizontal element 52 such that the tool bag 78 hangs between the belt loops 46 but does not move along the elongated horizontal element 52 past the belt loops 46. The integrated belt loops 46 can be spaced to allow desired, personalized placement of the tool bag 78 along a given stretch of the tool belt. Such personalized space can be provided on both the right-hand and left-hand side of the belt so that both right-handed and left-handed users can easily personalize the location. In such configurations, the elongated horizontal element 52 further comprises at least one retaining clement such as snaps or a hook and loop material such as Velcro®, to specifically retain the tool bag 78 in the desired position between the spaced-apart belt loops 46, and thereby to prevent the tool bags 78 from undesired horizontal movement along the waist belt.

In one embodiment, as shown in FIGS. 8A and 8B, the elongated horizontal element 52 is a waist belt featuring a heavy duty utility belt 80 and 5 belt loops 46. Loop #1 is at a first end of the belt, houses the end of heavy duty utility belt 80 and is not necessarily functional for the support of the tool bags 78. Loops #1-#2 and #4-#5, respectively, are spaced 8¼″ apart to receive tool bags 78, preferably the tool bags 78 discussed herein that have an exemplary 6.0″ attachment region to provide a 2¼″ horizontal position adjustment area. Belt loop #3 is located at the center back of the waist belt. An equal space of 3.5″ on each side of belt loop #3, i.e., between belt loop #3 and loops #2 and #4, respectively, can be provided. This allows for either a right hand or left hand worker to attach a hammer holder or other utility device holder such as a tape measure. In another embodiment, belt loops #2 and #4 are eliminated, so the horizontal position adjustment up to 12¾″ (3½″+8¼″+1.0″ belt loop width). Of course, these dimensions are exemplary; other desired dimensions, numbers of belt loops, etc., can be provided as desired.

Typically, the waist belt 24 of the harness is configured, for example by placement of belt loops 46, to hold only up to two tool bags 78, and can, if desired, be provided with at least one hammer holder or other additional tool carrier element. If desired, the hammer holder can be movable on the elongated horizontal element 52 such that the hammer holder can be switched from the right side to the left side of the user, and vice versa, to accommodate the handedness of the user.

In one embodiment, the tool bags 78 are physically attached to the elongated horizontal element 52 of the full body harness 2 using a hook and loop material such as Velcro®, although any suitable, desired attachment system such as snaps, detents, clamps, etc., can be used. This waist belt 24/safety harness tool bag retention system can be advantageous, for example, because it can eliminate the need for a separate tool belt that may itself require suspenders or other support.

In certain embodiments, there can be at least two belt loops 46 located to the right and left of the back center of the waist belt 24, and such belt loops 46 can be spaced to allow the hammer holder to be moved approximately three to four inches off center to provide for desired positioning of the hammer holder relative to the right- or left-handedness of the worker. Although the tool bag holding configuration of the waist belt 24 can be modified for any type of tool bags 78, in certain embodiments it is configured to be used with widely used tool bag designs in the industry.

In another embodiment, the elongated horizontal element 52 of the harness is a waist belt 24 that wraps all the way around the waist of a user with a minimum of 20″ overlap at the center (for an average sized user; longer belts can be provided for larger users). This can produce a more comfortable fit than partial wrap waist belts that place the heavy duty utility belt 80 at the worker's center, unprotected and thus creating a pinching and chaffing hazard.

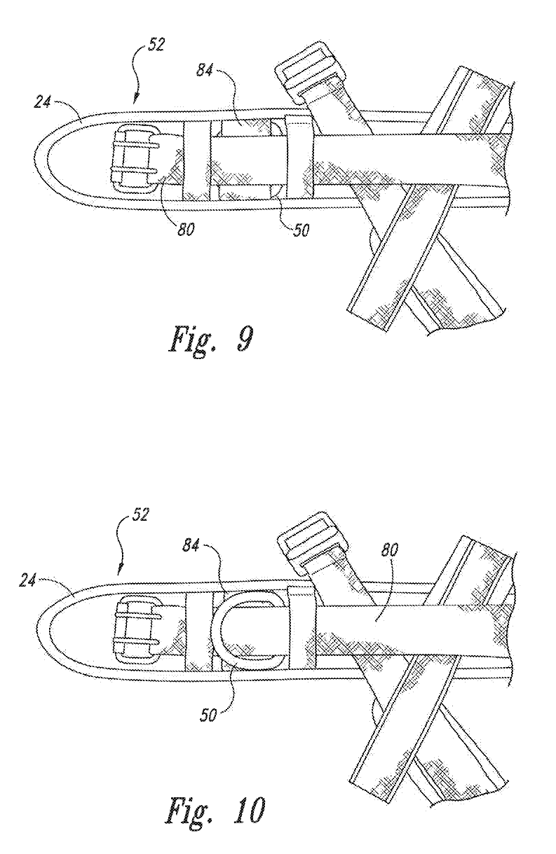

As shown for example in FIGS. 4, 9 and 10, in a further aspect, the waist belt 24 or other suitable structure of the full body harness 2 can have a safety line attachment element guard 84 configured to keep one or more safety line attachment elements such as a D-ring 50 safe and out of the way when not in use. For example, where the safety line attachment element is a side D-ring 50, the safety line attachment element guard 84 can be a forward belt loop configured to hold the D-ring 50 when it is not in use. As in FIG. 4, when not in use the D-ring 50 can be folded back towards the belt and placed under the safety line attachment element guard 84 on the waist belt 24 of the full body harness 2 and thereby effectively hidden from inadvertent catching of loose obstacles or involvement in activities, and therefore kept out of the way until use is desired. As in FIG. 10, the D-ring 50 can be outside the guard 84 when in use or when its availability is otherwise desired. The safety line attachment element guard 84 can also be a portion of a tool belt passing through the loops of the waist belt 24 of the full body harness 2, as in FIG. 9, such that the D-ring 50 can he tucked under the utility tool belt 80. This can be advantageous where, for example, the full body harness 2 is configured to have a comfortable, primary weight-bearing waist strap comprising a plurality of loops through which a separate belt passes (such belt can, if desired, be a tool belt holding a tool bag). When the side D-ring 50 is desired to be used, the D-ring 50 can be withdrawn or otherwise pulled out from under the safety line attachment element guard 84 and then if desired the tool belt can be fed through the D-ring 50 crossbar, with the loop of the D-ring 50 in turn attached to the safety line.

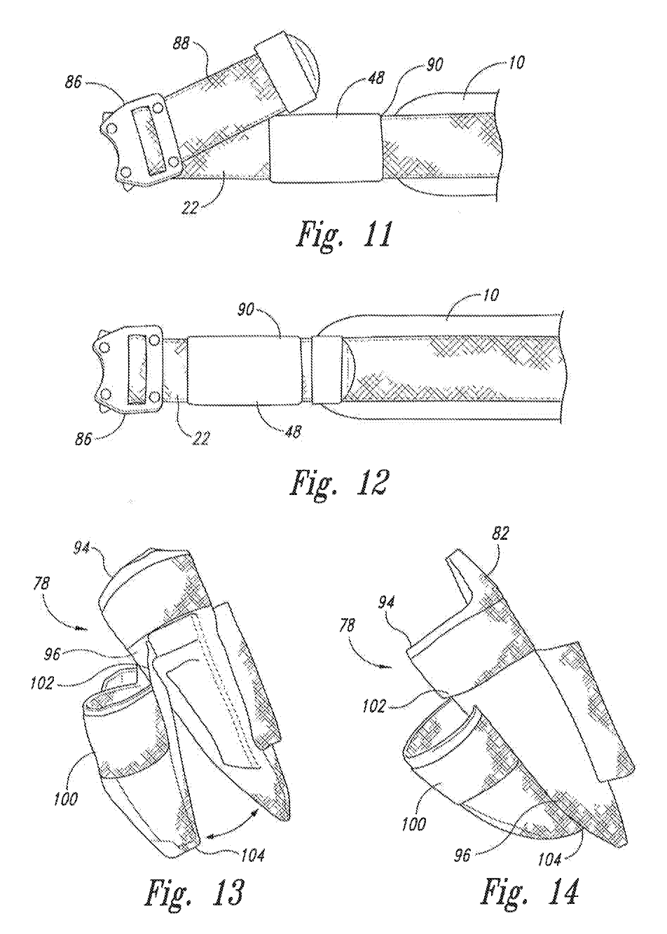

FIGS. 11 and 12 depict an elongated, elasticized webbing keeper 48. Such webbing keeper 48 comprises a substantial length of elasticized material that encapsulates at least the free end 88, and typically both sides, of webbing 22 passing through an adjustment buckle 86 (or other webbing length adjustor) causing a return of the webbing 22 back onto itself, or otherwise engendering a free end of a floppy material such as webbing (generically, herein, referred to as “webbing”). The elongated, elasticized webbing keeper 48 is longer than it is wide; it is wide enough to comfortably receive the free end of the webbing 22 and long enough to securely hold the free end 83 due to friction between the webbing keeper 48 while typically simultaneously avoiding the free end 88 of the webbing 22 exiting the far end 90 of the keeper and dangling free despite the presence of the keeper. Where the webbing folds back on itself, the elongated, elasticized webbing keeper 48 fits like a sleeve over both the feed portion and the loose end of the webbing. In other embodiments, for example, the elongated, elasticized webbing keeper 48 can be retained on another structure of the full body harness 2 and hold (keep) the free end of the webbing from flopping around, inadvertently catching on objects, etc.

In still a further aspect, as shown for example in FIGS. 8B, 13 and 14, the systems, etc., herein comprise tool bags 78. The tool bags discussed herein can be used both with the harness systems herein and separately, either on their own or with other safety harnesses or other tool belts.

Typical tool bags 78 provide fairly deep pouches having linear walls. The tool bags 78 herein have deeper pouches 92 and, more importantly, have a reduced-size opening 94 at the top of the tool bag 78 so that the tool bag 78 forms a slightly enclosed pouch 96. This helps hold tools in the bag despite motion by the user, yet does not significantly impede the user's access to the tools in the bag. For example, the depth of the tool bags 78 can be increased by about 1″ while the top edge of the tool bag enclosed pouch 96 can be reduced from about 7.5″ to about 6″. This reduction in the size of the opening advantageously also allows the tool bag 78 to take up less space on the tool belt (such as the elongated horizontal element 52 discussed herein), thereby permitting improved ability to position—and re-position—the bag 78 in a desired location along the tool belt.

In some embodiments, the tool bags 78 further comprise one or more drain holes 98 in the bottom of the bag. The drain holes 98 can be grommets or other suitable structures. Still further, the tool bags 78 can be configured to further provide for one, two or more accessory bags 100 that are attached to the tool bag 78. The accessory bag 100 is attached at least to the top 102 of the accessory bag 100 to the upper region of the tool bag 78, which can provide a free swinging accessory bag 100 as shown in FIG. 13, if desired. The accessory bag 100 can also be attached at the bottom 104 of the accessory bag 100 to the bottom region of the tool bag 78, which can reduce swinging of the accessory bag 100, which swinging can throw a user off balance or spill the contents of the accessory bag or otherwise be undesirable.

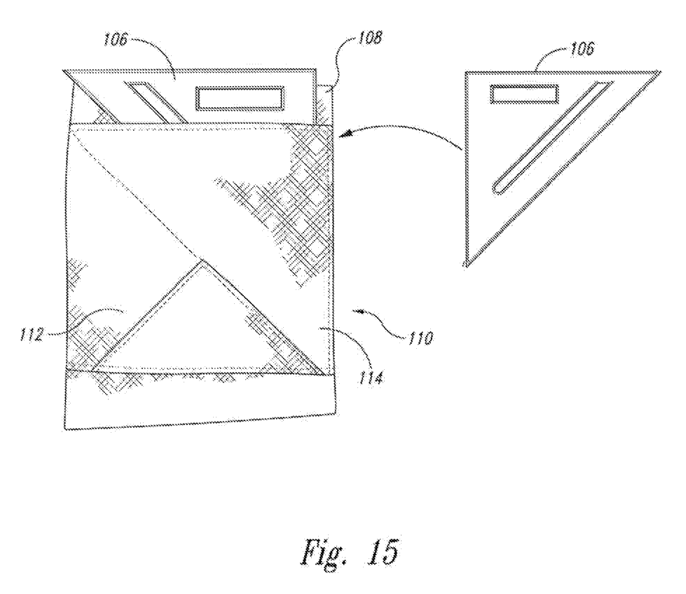

In still yet another embodiment, as shown fur example in FIG. 15, the tool bags 78 (or even the elongated horizontal element 52 or other support structure) comprises a speed square pocket 108 or holder for holding a speed square 106. The speed square pocket 108 can be typically located inside a tool or accessory pouch such as primary tool pouch 78. The speed square pocket 108 is configured with dual speed square retention areas 110, both a left hand speed square pocket 112 and a right hand speed square pocket 114 so that the speed square pocket 108 and speed square 106 can be easily used by both left hand or right hand users. Generally, the speed square 106 is a triangular shape tool that may be used almost as often as a tape measure. In the past, a primary tool pouch had a triangular-shaped pocket sewn to the back of its pouch to store the square but there was only one such pocket. As shown in FIG. 15, the speed square holder herein comprises a dual speed square pocket 110 comprising opposed triangular recesses 112, 114, which enhances the ability of both left hand or right hand users to have a desired orientation of the square when storing and retrieving.

The present application is further directed to methods of making the various elements of the systems and apparatus herein, including making the systems and apparatus themselves from such elements, as well as to methods of using the same, including for example donning and/or doffing the full body harnesses, donning and/or doffing the tool bags 78, draining water from the tool bags 78 having the one or more drain holes, securing a loose end of a webbing or a side D-ring 50, etc.

All terms used herein, are used in accordance with their ordinary meanings unless the context or definition clearly indicates otherwise. Also unless expressly indicated otherwise, the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to he interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion herein.

1-84. (canceled)

85. A full body safety harness system wherein at least 50% of its outwardly visible surface comprises highly visible outer material comprising at least one of a high visibility background material in combination with retroreflective material or a dual purpose retroreflective material.

86. The system of claim 85 wherein the highly visible outer material is located at least at a front, side, back and over the shoulder of the harness.

87. The system of any one of claims 85 to 86 wherein the highly visible outer material and harness comply with ANSI 107-2010 requirements for class 1 apparel non-fall-arrest safety vests.

88. A method comprising:
providing a full body safety harness system according to claim 85 to a worker and the worker donning the full body safety harness system.

89. The method of claim 88 wherein the method further comprises the harness retroreflecting light at least at a front, side, back and shoulder of the harness.

90. The method of claim 88 wherein the method further comprises the harness retroreflecting light in compliance with ANSI 107-2010 requirements for class 1 apparel non-fall-arrest safety vests.
